(19) United States
(12) Patent Application Publication
(10) Pub. No.: US 2008/0301273 A1
(43) Pub. Date: Dec. 4, 2008

(54) CENTRALLY ASSIGNING BRANCH SPECIFIC NETWORK ADDRESSES

(76) Inventors: MICHAEL W. BROWN, Austin, TX (US); Brian K. Howe, Round Rock, TX (US); Radhakrishnan Sethuraman, Austin, TX (US); Manual Silveyra, Round Rock, TX (US)

Correspondence Address: Greg Goshorn, P.C., 9600 Escarpment, Suite 745-9, AUSTIN, TX, 78749, US

(21) Appl. No.: 11/755,804

(22) Filed: May 31, 2007

(51) Int. Cl. G06F 15/177

(52) U.S. Cl. 709/222

(57) ABSTRACT

Provided is a method for centrally assigning branch specific network addresses in a domain host control protocol (DHCP) environment. A local router receives requests for IP address assignment from a computing device at one location and forwards the request to a centralized DHCP (CDHCP) server at a different location. The CDHCP server evaluates information associated with the request to determine the location of the requesting computer and assigns an IP address based upon the location. The CDCHP server correlates location specific data to the IP address entry. In this manner, a centralized DHCP server is able to administer IP address for multiple locations and assign location specific data to the requesting computer. The determination of a location of a requesting computer is based on information such as a reverse look-up of the originating signal and analysis of network traffic. The disclosed technology provides centralized control of a networking infrastructure.

### TECHNICAL FIELD

The present invention relates generally to network communication and, more specifically, to a system and method for assigning Internet protocol (IP) addresses from a centrally located domain host configuration protocol (DHCP) server.

### BACKGROUND OF THE INVENTION

Since computers were invented, users have been inventing ways to connect them together. Advantages to computer connectivity are numerous and increasing in numbers. For example, computers connected to each other can share data and applications as well as resources such as printers and communication connections. One big leap forward in the area of computer connectivity is the Internet, a collection of computers that span the world and share a common communication protocol. Typically, each computer that accesses the resources of the Internet is assigned an internet protocol (IP) address that uniquely identifies that computer and enables information to be transmitted and received from other computers.

Although there are billions of possible IP addresses available, sometimes to is advantageous for groups of computers to share a particular IP address or group of IP addresses. For example, a local area network (LAN) may have a range of defined IP addresses that are assigned to individual computers as needed. To automatically implement this functionality, DHCP has been developed.

A DHCP server assigns an IP address to a requesting computer for the purpose of communicating both locally within a LAN and to other computers across the Internet. For example, a computer such as a laptop typically connects to a particular LAN, requests an IP address from a DHCP server also connected to the LAN and then employs the assigned IP address to communicate locally and across the Internet. Each IP addressed is assigned to a requesting computer for a specific period of time, typically ranging from an hour to several months, although the period may also be set to not expire. The specific period of time a particular IP address is assigned to a device is referred to as a “lease” for the device. The DHCP server does not assign the same IP address to a second computer while a first computer is “leasing” the address. In this manner, a limited number of IP address can be used by a larger number of computers, thus enabling a network to provide connectivity to multiple devices using fewer IP addresses than would otherwise be necessary.

What is wanted and needed is a system and method for assigning IP addresses across multiple LANs from a centrally administered DHCP server. In other words, a business with multiple LANs would benefit from a system in which a DHCP service is centrally located. Further, it would be beneficial for centralized IP addressing to be based upon criteria such as the physical location of a requesting computer or some other feature. For example, a salesman who connects to a LAN at a remote office may be assigned an IP address corresponding to a LAN at the remote office rather than an IP address based upon the home location of the laptop or vice versa. Under different circumstances, the laptop may be assigned an IP address corresponding to the LAN of the home office.

### SUMMARY OF THE INVENTION

Provided is a method for centrally assigning branch specific network addresses in a domain host control protocol (DHCP) environment. A local router receives requests for IP address assignment from a computing device at one location and forwards the request to a centralized DHCP (CDHCP) server at a different location. The CDHCP server evaluates information associated with the request to determine the location of the requesting computer and assigns a location-dynamic IP address based upon the location, user-defined parameters or some other feature. In addition, the CDCHP server correlates location specific data to the IP address entry. An example of address specific data includes, but is not limited to, printer and router information corresponding to the location. In this manner, a centralized DHCP server is able to administer IP address for multiple locations and assign location specific data to the requesting computer based upon the current location of the computer.

A requesting computer may be assigned multiple IP address, each address tailored for a single purpose. For example, an application that functions as a print server may be assigned an IP address associated with the location of a particular printer while an application that uses a remote database may be assigned an IP address associated with the location of the corresponding database server. This type of IP address assignment enables an enterprise to centralize control over which computers are attached to a network, reduces the number of DHCP servers necessary to administer a network and enables the implementation of a hardware based media access control (MAC) security system.

The determination of a location of a particular computer is based on information such as, but not limited to, a reverse look-up of the originating signal and analysis of network traffic. The disclosed technology provides centralized control of a networking infrastructure.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is a block diagram of an example of a computing system architecture that implements the claimed subject matter, including a centralized dynamic host configuration protocol (CDHCP) server.

FIG. 2 is a block diagram of the CDHCP server of FIG. 1 in more detail.

FIG. 3 is a flowchart of an IP Request Address process executed by a client computer to establish an address on a computer network.

FIG. 4 is a flowchart of a Retrieve Address process executed by the router of FIG. 1.

FIG. 5 is a flowchart of an Assign Address process implemented by the CDHCP server of FIGS. 1 and 2 as part of the location-dynamic IP address assignment process of FIG. 3.

FIG. 6 is a flowchart of an Identify Source process employed in conjunction with the Assign Address process of FIG. 5.

### DETAILED DESCRIPTION OF THE FIGURES

Although described with particular reference to a computing system that implements dynamic host configuration protocol (DHCP), the claimed subject matter can be implemented in any information technology (IT) system in which centralized control of network addresses is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also include, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for centralized network address assignment. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

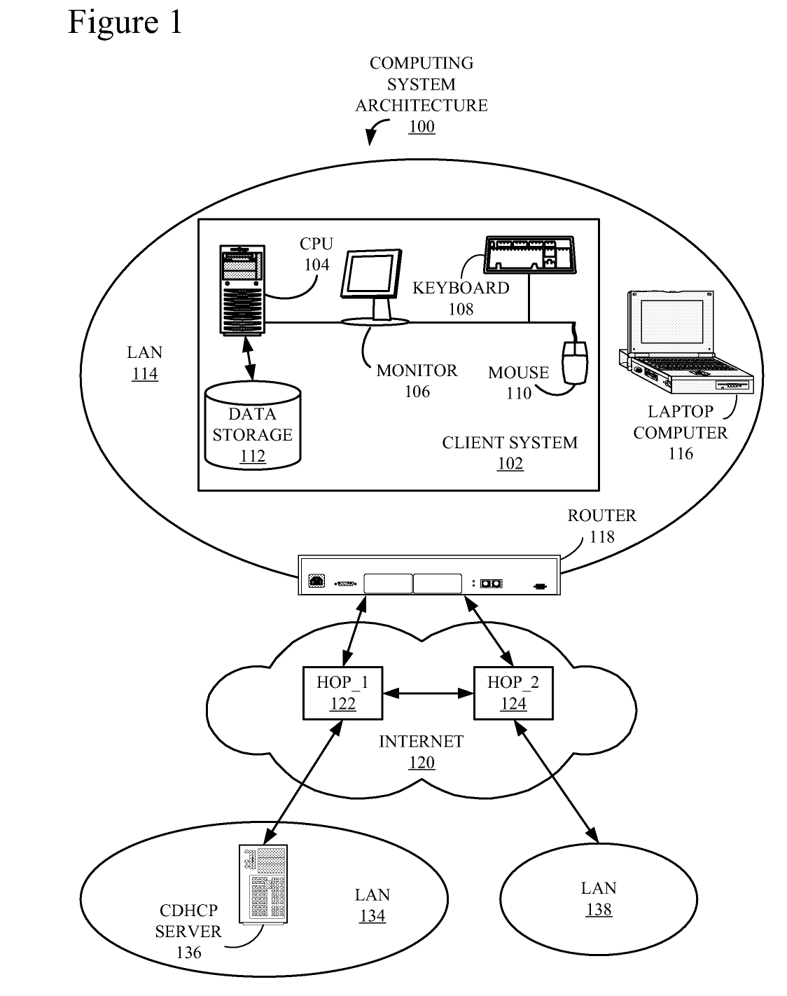

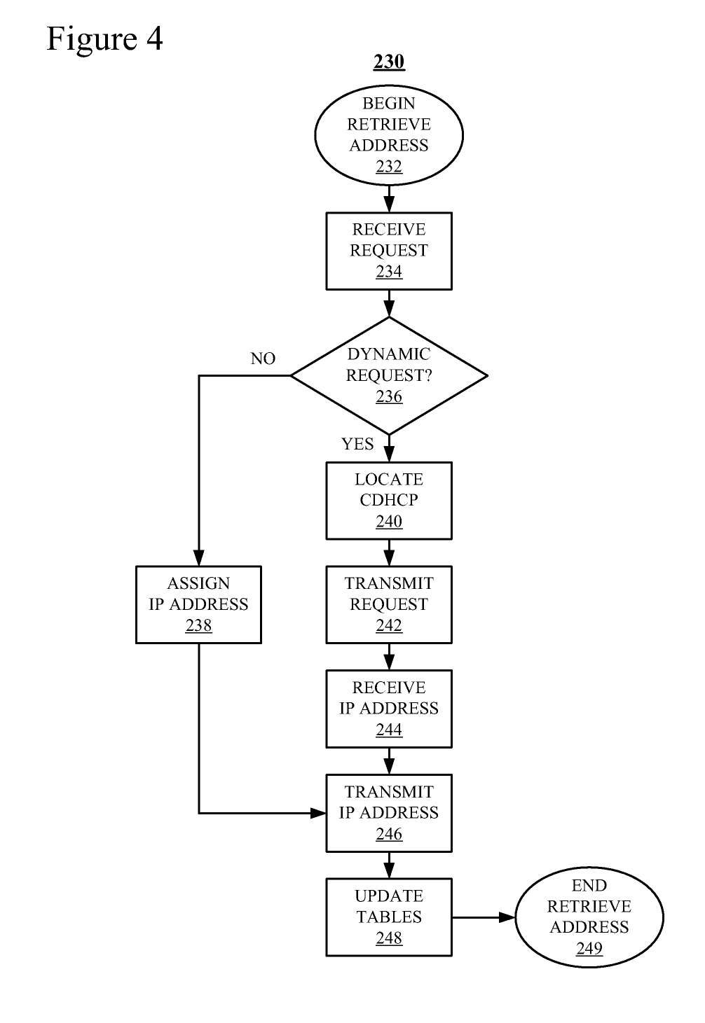

Turning now to the figures, FIG. 1 is a block diagram of an example of a computing system architecture 100 that implements the claimed subject matter. Computing system 100 includes a local area network (LAN) 114, a LAN 134 and a LAN 138, each of which are communicatively coupled and communicate with each other via the Internet 120. Coupled to LAN 114 are a client system 102, a laptop computer, or “laptop”, 116 and a router 118. Those with skill in the computing and communication arts should be familiar with computers, LANs and routers. It should be noted that router 118, in addition to the typical logic associated with a router, also includes logic for initiating an implementation of the claimed subject matter (see FIG. 4).

Computing system 102 includes a central processing unit (CPU) 104, coupled to a monitor 106, a keyboard 108 and a mouse 110, which together facilitate human interaction with computer 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Computing system 102 is one example of a device that may take advantage of the claimed subject matter although the following description focuses on an implementation by laptop 116. Although not shown, laptop 116 also includes a monitor, keyboard and a touch pad for human interaction, all of which are typically integrated into such a device rather than stand-alone components.

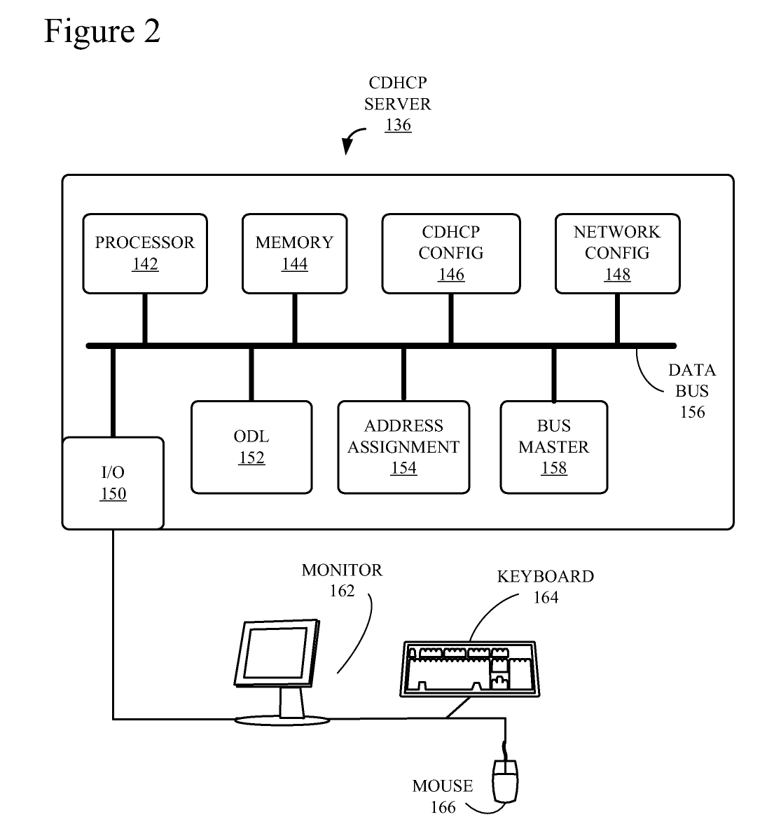

LAN 134 includes a centralized DHCP (CDHCP) server 136 that implements the claimed subject matter. CDHCP server 136 is explained in more detail below in conjunction with FIGS. 2-6. LAN 114 is coupled to LAN 134 via router 118 and the Internet 120. Included in Internet 120 are examples of two relay points, a hop_1 122 and a hop_2 124. In this example, a signal from a computing device such as client system 102 or laptop 116 is routed to CDHCP 136 on LAN 134 via hop_1 122 or via hop_2 124 and hop_1 122. Those with skill in the computing and/or communication arts should appreciate that FIG. 1 is a simplified illustration of a networked computing system used for illustrative purposes only and that there are many possible configurations relevant to the disclosed technology. For example, LAN 114, LAN 134 and LAN 138 would typically include additional computing devices like client system 102. In addition, LAN 134 and LAN 138 would probably include routers (not shown) like router 118.

FIG. 2 is a block diagram of CDHCP server 136 of FIG. 1 in more detail. Functional modules include a processor 142, a memory 144, a CDHCP configuration (config.) module 146, a network config. module 148, an Input/Output (I/O) module 150, an origination detection logic (ODL) module 152 and an address assignment module 154. Each of modules 142, 144, 146, 148, 150, 152 and 154 are coupled to a data bus 156, which enables modules 142, 144, 146, 148, 150 and 152 to communicate with each other. Traffic on data bus 156 is controlled by a bus master 158. Coupled to CDHCP server 136 via I/O module 150 are a monitor 162, a keyboard 164 and a mouse 166, which enable human interaction with CDHCP 136.

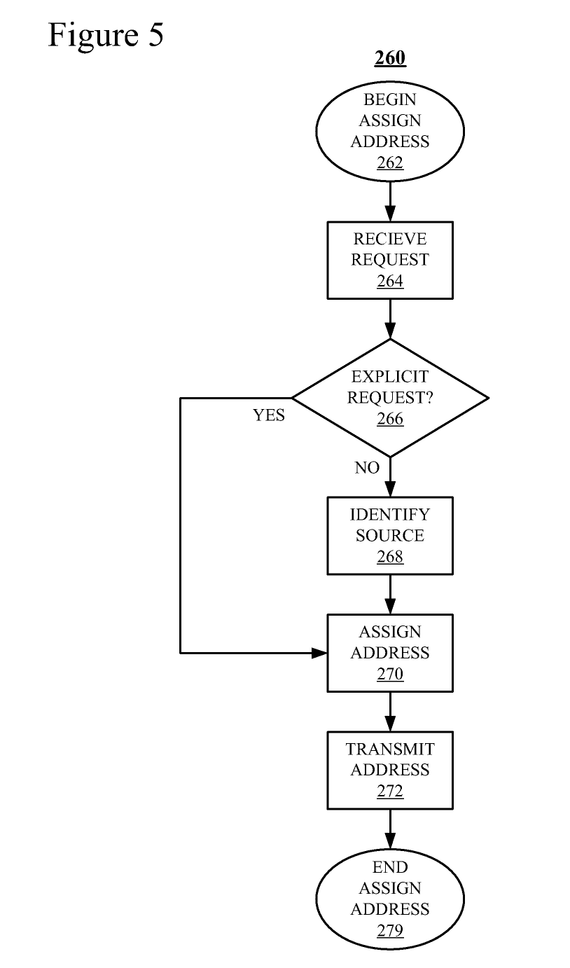

Processor 142 executes logic associated with modules 144, 146, 148, 150, 152 and 154 to implement the claimed subject matter. Memory 144 provides storage for data and executables employed by processor 142. CDHCP configuration module 146 provides non-volatile storage for information employed in the claimed subject matter. Simply stated, module 146 stores information related to the configuration of CDHCP server 136 itself including, but not limited to, parameters for default lease times and the priority execution order of available location determination processes (see FIG. 5).

Network config. module 148 stores information relating to LAN 114 (FIG. 1), LAN 134 (FIG. 1), LAN 138 (FIG. 1) and Internet 120 (FIG. 1), including hop_1 122 (FIG. 1) and hop_2 124 (FIG. 1) of architecture 100 (FIG. 1). Specifically, network config. module 148 stores information such as currently assigned and available IP addresses, information related to available IP address such as the location, and information employed by ODL module 152 to determine a source of an address assignment request.

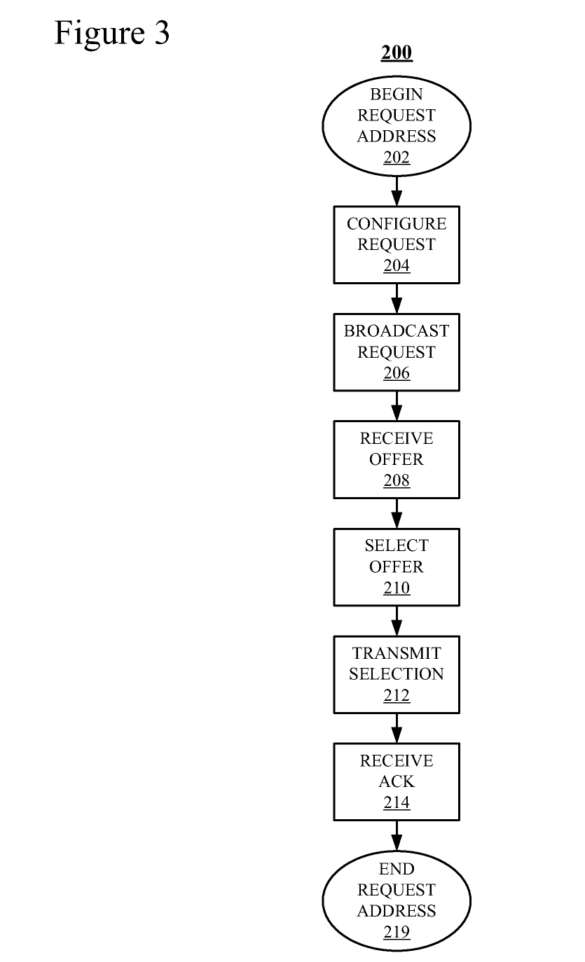

Input/Output (I/O) module 150 handles communication between CDHCP server 136 and other devices such as laptop computer 116 (FIG. 1) and client system 102 (FIG. 1). ODL module 152 determines the source of an address assignment request based upon an analysis of a particular address assignment request and information stored in network config. module 148. Address assignment module 154 employs data stored in conjunction with network config. module 148 and data generated by ODL module 152 to assign an IP address in response to an address assignment request. The functions of modules 142, 144, 146, 148, 150, 152 and 154 are described in more detail below in conjunction with FIGS. 3-6.

FIG. 3 is a flowchart of an IP Request Address process 200 executed by a client computer to establish an address on a computer network. In this example, the client computer is laptop 116 (FIG. 1) and the computer network is LAN 114. Process 200 is executed on the CPU (not shown) of laptop 116. Process 200 is initiated when laptop 116 is first coupled to LAN 114 (FIG. 1) and initiates an attempt to establish an address for transmitting and receiving messages from other devices on LAN 114 and from other devices on other networks such as LAN 134 (FIG. 1) via the Internet 120 (FIG. 1). Although describe with respect to laptop 116 and LAN 114, process 200 applies equally to any computer on any network. For example, process 200 also describes laptop 116 on a different network or a different computer (not shown) connecting to LAN 138 (FIG. 1) or some other LAN.

Process 200 starts in a “Begin Request Address” block 202 and proceeds immediately to a “Configure Request” block 204. During block 204, logic associated with the claimed subject matter in laptop 116 determines whether or not to transmit a standard IP address request or a location-dynamic IP address request. In other words, in one embodiment, a particular computing system may elect whether or not to participate in the location dynamic IP address assignment of the claimed subject matter. In another embodiment, whether or not a particular computer elects to request a typical or location-dynamic IP address may be based upon configuration parameters corresponding to the particular computer stored in CDHCP configuration module 146 (FIG. 2) of CDHCP server 136 (FIGS. 1 and 2). In another embodiment, all computers requesting IP address are processed according to the disclosed location-dynamic IP address assignment. Further, whether or not a particular computer is assigned a typical or location-dynamic IP address may be determined based upon conditions associated with the request. For example, laptop 116 may be assigned a location-dynamic IP address if the request originates from LAN 114 but processed normally if the request originates from LAN 138 (FIG. 1).

During a “Broadcast Request” block 206, laptop 116 transmits via LAN 114 (FIG. 1) the IP address request generated during block 204. This message is typically broadcast rather than directed to a specific target address because when a computer first connects to a network, the computer may not know of a specific address to which to transmit a request for an IP address. The processing associated with servicing this request on the server and network side of the requesting computer is described in more detail below in conjunction with FIGS. 4-6.

During a “Receive Offer” block 208, laptop 116 may receives one or more potential IP addresses because the broadcast request transmitted during block 206 may be received by multiple DHCP servers, each of which transmit a reply. During a “Select Offer” block 210, process 200 chooses one of the offers received during block 208. In addition, the various communication tables and parameters on laptop 116 are updated to reflect the assigned IP address. During a “Transmit Selection” block 212, process 200 broadcasts a message indicating the IP address selected during block 210. In this manner, other servers and computers may update tables that enable each to know how to communicate with each other,

During a “Receive Acknowledgement (Ack)” block 214, process 200 receives an acknowledgement message from the particular DHCP server from which the IP address selected during block 210 originated so that the particular server may update tables to ensure proper maintenance of the IP address. Finally, process 200 proceeds to an “End Request Address” block 219 in which process 200 is complete.

FIG. 4 is a flowchart of a Retrieve Address process 230 executed by the router 118 of FIG. 1. Process 230 is executed on a processor (not shown) and memory (not shown) of router 118. It should be noted that router 118, in addition to the typical logic and components associated with a standard router, also includes logic for initiating an implementation of the claimed subject matter as described here in FIG. 4. The following example is described using a request for an IP address from laptop computer 116 (FIG. 1) transmitted to router 118 via LAN 114 (FIG. 1). Those with skill in the computing and communication arts should appreciate that there are many possible devices and networking configurations in which the claimed subject matter is applicable.

Process 230 starts in a “Begin Retrieve Address” block 232 and proceeds immediately to a “Receive Request” block 234. During block 234, router 118 receives a request for an IP address from laptop computer 116. In a typical scenario, when a user of computer 116 plugs into LAN 114, a program associated with computer 116 attempts to establish a connection to LAN 114 for computer 116 so that computer 116 may send and receive messages across LAN 114. In this example, the request received corresponds to the request broadcast during Broadcast Request block 206 of IP Request Address process 200, described above in conjunction with FIG. 3.

During a “Dynamic Request?” block 236, process 230 determines whether of not the IP address request received during block 234 is a dynamic address request in accordance with the claimed subject matter. In other words, some devices attempting to connect to LAN 114 may take advantage of the disclosed technology and some may not. The determination of whether or not a particular device is making a typical or a dynamic IP address request may be based upon several factors. In one embodiment, the IP request includes data explicitly indicating that the request is a dynamic IP address request. In another embodiment, router 118 makes the determination based either upon data associated with the request, such as, but not limited to, the specific device making the request. For example, a determination based upon the specific device may be predicated upon the type of device, a list of specific devices that are authorized to submit dynamic IP address requests or both.

In the event that the requesting device is not taking advantage of the claimed subject matter, process 230 proceeds to an “Assign IP Address” block 238 during which router 118 assigns an IP address according to standard IP address allocation procedures, as described above in the Background. If, during block 236, process 230 determines that the IP address received during block 234 should be handled in a dynamic fashion in accordance with the disclosed technology, control proceeds to a “Locate CDHCP” block 240. During block 240, process 230 determines the location, or IP address, of CDHCP server 136 (FIG. 1 and 2). In this example CDHCP server 136 is configured to process dynamic IP address request according to the claimed subject matter.

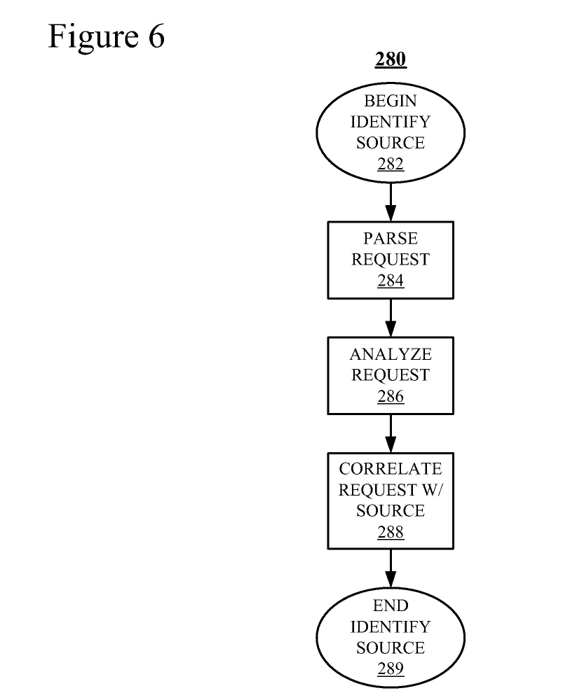

Once CDHCP server 136 is located during block 240, process 230 proceeds to a “Transmit Request” block 242. During block 242, process 230 transmits a request for an IP address to CDHCP server 136, which process the request as described below in conjunction with FIGS. 5 and 6. During a “Receive IP Address” block 244, process 230 receives an assigned IP address from CDHCP 136. During a “Transmit IP Address” block 246, the IP address received during block 244 is transmitted to the requesting device, which in this example is laptop computer 116, and to all other routers that may need to update their information. During an “Update Tables” block 248, process 230 updates the routing tables associated with router 118 to reflect the assigned IP address associated with computer 116. Finally, process 230 proceeds to an “End Retrieve Address” block 249 in which process 230 is complete.

FIG. 5 is a flowchart of an Assign Address process 260 implemented by CDHCP server 136 of FIGS. 1 and 2 as part of the location-dynamic IP address assignment processes of FIGS. 3 and 4. Process 260 is stored in memory 144 (FIG. 2) and executed on processor 142 (FIG. 2). As explained above in conjunction with FIG. 2, various parameters and logic employed during process 260 are stored in CDHCP configuration module 146, network configuration module 148, ODL module 152 and address assignment module 154.

Process 260 starts in a “Begin Assign Address” block 262 and proceeds immediately to a “Receive Request” block 264. During block 264, process 260 receives the request transmitted by router 118 (FIG. 1) during Transmit Request block 242 (FIG. 4) of Retrieve Address process 230 (FIG. 4). During an “Explicit Request?” block 266, process 260 determines whether or not the IP address request is a request for a specific IP address or an IP address associated with a specific location such as LAN 114, LAN 134 or LAN 138. If not, process 260 proceeds to an “Identify Source” block 268 during which process 260 determines the source of the request received during block 264. Typically, the source of the request includes both the LAN and the device that originated the request, i.e. LAN 114 (FIG. 1) and laptop 116 (FIG. 1), respectively, in this example. Processing associated with block 268 is described in more detail below in conjunction with FIG. 6.

Once a source has been identified during block 268 or process 260 has determined during block 266 that the address request is for a specific LAN or router, process 260 proceeds to an “Assign Address” block 270. During block 270, CDHCP server 136 assigns a location-dynamic IP address based upon either the source of the request as determined during block 268 or based upon the specific request as determined during block 266. During a “Transmit Address” block 272, process 260 transmits the IP address assigned during block 270 to the router from which the request originated. Finally, process 260 proceeds to an “End Assign Address” block 279 in which process 260 is complete.

FIG. 6 is a flowchart of an Identify Source process 280 employed in conjunction with the Assign Address process 260 of FIG. 5. Like process 260, process 280 is implemented by CDHCP server 136 of FIGS. 1 and 2 as part of the location-dynamic IP address assignment processes of FIGS. 3 and 4.

Process 280 starts in a “Begin Identify Source” block 282 and proceeds immediately to a “Parse Request” block 284. During block 284, process 280 scans an IP address request transmitted to CDHCP server 136 during Transmit Request block 242 (FIG. 4) from, in this example, router 118 (FIG. 1) and received by CDHCP 136 during Receive Request block 264 (FIG. 5) of Assign Address process 260. During an “Analyze Request” block 286, process 280 determines specific parameters associated both with the request parsed during block 284 and the source of the request, in this example laptop computer 116 (FIG. 1) and LAN 114. Information processed to determine the source of the request may include a path analysis corresponding to the path taken by the request. Two different examples of possible paths are via hop_1 122 (FIG. 1) or via hop_2 124 (FIG. 1) and then hop_1 122.

During a “Correlate Request with Source” block 288, process 280 determines the router associated with the source as determined during block 286. Finally, process 280 proceeds to an “End Identify Source” block 289 in which process 280 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for controlling network address assignment, comprising:
receiving at a first computing device a network address assignment request;
forwarding the network address assignment request to a central address management server;
determining a set of address assignment parameters based upon a feature of the network address assignment request; and
assigning a first network address based upon the set of address assignment parameters.

2. The method of claim 1, wherein the first computing device is on a first network and the central address management server is on a second network.

3. The method of claim 2, wherein the assigned first network address may correspond to a network address request on either the first network or the second network depending upon the feature of the network address assignment request.

4. The method of claim 1, the determination of the feature comprising ascertaining a geographical location corresponding to a computing device that is the source of the network address assignment request.

5. The method of claim 1, the determination of the feature comprising analyzing a routing path corresponding to the network address assignment request.

6. The method of claim 1, the determination of the feature comprising analyzing the network address assignment request by employing a reverse look-up table to determine a source for the network address assignment.

7. The method of claim 1, further comprising:
assigning a second network address based upon the set of address assignment parameters;
wherein the first network address is employed by a first application and the second network address is employed by a second application.

8. A system for controlling network address assignment, comprising:
a central address management server on a first network;
a computing device;
logic for receiving at the computing system a network address assignment request;
logic for forwarding the network address assignment request to the central address management server;
logic for determining a set of address assignment parameters based upon a feature of the network address assignment request; and
logic for assigning a first network address based upon the set of address assignment parameters.

9. The system of claim 8, wherein the first computing device is on a second network.

10. The system of claim 9, wherein the assigned first network address may correspond to a network address request on either the first network or the second network depending upon the feature of the network address assignment request.

11. The system of claim 8, the logic for determining the feature comprising logic for ascertaining a geographical location corresponding to a computing device that is the source of the network address assignment request.

12. The system of claim 8, the logic for determining the feature comprising logic for analyzing a routing path corresponding to the network address assignment request.

13. The system of claim 8, the logic for determining the feature comprising logic for analyzing the network address assignment request by employing a reverse look-up table to determine a source for the network address assignment.

14. The system of claim 8, further comprising:
logic for assigning a second network address based upon the set of address assignment parameters;
wherein the first network address is employed by a first application and the second network address is employed by a second application.

15. A computer programming product for controlling network address assignment, comprising:
a memory;
logic, stored on the memory for execution on a processor, for receiving at a first computing device on a first network a network address assignment request;
logic, stored on the memory for execution on a processor, for forwarding the network address assignment request to a central address management server on a second network;
logic, stored on the memory for execution on a processor, for determining a set of address assignment parameters based upon a feature of the network address assignment request; and
logic, stored on the memory for execution on a processor, for assigning a first network address based upon the set of address assignment parameters.

16. The computer programming product of claim 16, wherein the assigned first network address may correspond to a network address request on either the first network or the second network depending upon the feature of the network address assignment request.

17. The computer programming product of claim 15, the logic for determining the feature comprising logic for ascertaining a geographical location corresponding to a computing device that is the source of the network address assignment request.

18. The computer programming product of claim 15, the logic for determining the feature comprising logic for analyzing a routing path corresponding to the network address assignment request.

19. The computer programming product of claim 15, the logic for determining the feature comprising logic for analyzing the network address assignment request by employing a reverse look-up table to determine a source for the network address assignment.

20. The computer programming product of claim 15, further comprising:
logic, stored on the memory for execution on a processor, for assigning a second network address based upon the set of address assignment parameters;
wherein the first network address is employed by a first application and the second network address is employed by a second application.
